(19) United States
(12) Patent Application Publication
(10) Pub. No.: US 2006/0253770 A1
(43) Pub. Date: Nov. 9, 2006

(54) Point-to-talk service

(76) Inventors: Qi Bi, Morris Plaints, NJ (US); Qinqing Zhang, Morganville, NJ (US)

Correspondence Address: WILLIAMS, MORGAN & AMERSON, 10333 RICHMOND, SUITE 1100, HOUSTON, TX, 77042, US

(21) Appl. No.: 11/122,637

(22) Filed: May 5, 2005

(51) Int. Cl. G06F 17/00

(52) U.S. Cl. 715/500; 719/320

(57) ABSTRACT

The present invention provides a method of wireless communication using a mobile unit. The method includes establishing a wireless communication link in response to an indication provided using a graphical user interface associated with the mobile unit.

### BACKGROUND OF THE INVENTION

1. Field of the Invention

This invention relates generally to communication systems, and, more particularly, to wireless communication systems.

2. Description of the Related Art

Wireless communication systems, such as cellular telephone networks, generally include one or more mobile units that may establish wireless communication links with at least one base station that is communicatively coupled to the wireless communication system. Exemplary mobile units include, but are not limited to, mobile phones, personal data assistants (PDA), smart phones, laptop computers, and text messaging devices. The wireless communication systems provide a variety of services related to voice and/or data communication. For example, conventional wireless communication systems may provide a push-to-talk service to subscribers.

Push-to-talk is a relatively new mobile application that can be deployed in cellular networks. Push-to-talk is a walkie-talkie type of dispatch service that a user may initiate by pressing a dedicated button on a mobile unit such as a regular mobile phone or a PDA type of device. When the dedicated button is pressed, the mobile unit initiates a half-duplex communication link to one or more selected mobile units. For example, when the push-to-talk service is activated, a buddy list may be shown on a screen on the mobile unit. The user may select one or more users from the list and then press the dedicated button. After the user hears a beep, he starts to talk. When the user releases the dedicated button, one other user may speak by pressing a dedicated button on their mobile unit. For example, the speaking user may release the dedicated button and wait for the called person(s) to answer. After the conversation, the user may press an end button or simply hang up to end the call.

Push-to-talk services may be relatively inexpensive and provide a convenient way to speak to a selected group of users in the wireless indication network. Thus, push-to-talk services are frequently used by users that may have a need to speak immediately to one or more predetermined users. For example, push-to-talk is often used by police officers, taxi drivers, truck drivers and IT managers. However, push-to-talk services also have a number of disadvantages. For example, only one user may talk at a time because the push-to-talk service operates in half duplex mode. Moreover, the user may only talk while the dedicated button is pressed.

### SUMMARY OF THE INVENTION

The present invention is directed to addressing the effects of one or more of the problems set forth above. The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one embodiment of the instant invention, a method of wireless communication using a mobile unit is provided. The method includes establishing a wireless communication link in response to an indication provided using a graphical user interface associated with the mobile unit.

In another embodiment of the present invention, a method is provided for wireless communication with a mobile unit. The method includes receiving an indication of a wireless communication link provided using a graphical user interface associated with the mobile unit and forming the wireless communication link in response to receiving the indication.

### BRIEF DESCRIPTION OF THE DRAWINGS

The invention may be understood by reference to the following description taken in conjunction with the accompanying drawings, in which like reference numerals identify like elements, and in which:

FIG. 1 conceptually illustrates one exemplary embodiment of an architecture of a communication system, in accordance with the present invention;

FIGS. 2A and 2B conceptually illustrate one exemplary embodiment of a mobile device, in accordance with the present invention; and

FIG. 3 conceptually illustrates operation of one exemplary embodiment of a mobile device, such as the mobile device shown in FIGS. 2A and 2B, in accordance with the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

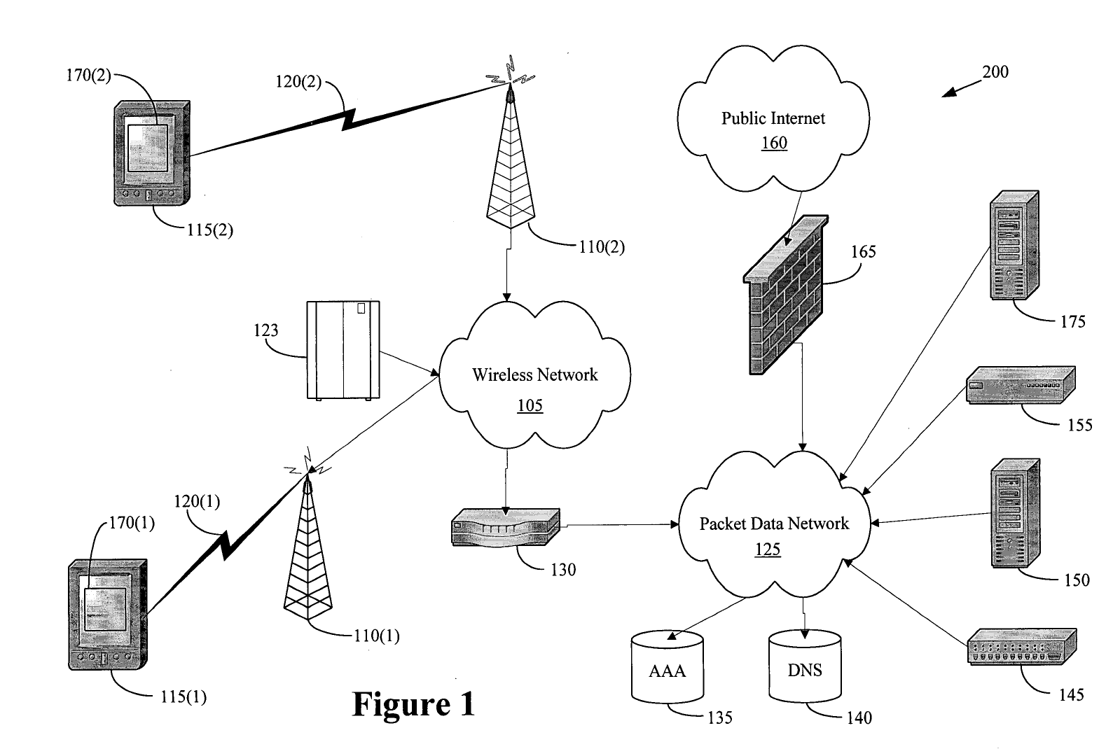

Referring now to FIG. 1, one exemplary embodiment of an architecture of a communication system 100 is shown. In the illustrated embodiment, the communication system 100 includes a wireless network 105 that is communicatively coupled to base stations 110(1-2). The wireless network 105 and the base stations 110 (1-2) provide wireless connectivity according to one or more wireless communication systems. Exemplary wireless communication systems include a Universal Mobile Telecommunication Systems (UMTS), a Global System for Mobile communications (GSM), a Code Division Multiple Access (CDMA or CDMA 2000) systems, an Evolution, Data Only (EVDO) system, and the like. However, persons of ordinary skill in the art having benefit of the present disclosure should appreciate that the present invention is not limited to these exemplary wireless communication systems. In alternative embodiments any desirable wireless communication system may be used to provide wireless connectivity. Furthermore, the wireless network 105 and/or the base stations 110 (1-2) may, in alternative embodiments, include wired connections that operate according to one or more wired communication systems.

The communication system 100 includes mobile devices 115(1-2). Exemplary mobile devices 115(1-2) include, but are not limited to, mobile phones, personal data assistants, smart phones, laptops, and text messaging devices. In the interest of clarity, only two mobile devices 115(1-2) are shown in FIG. 1. However, persons of ordinary skill in the art having benefit of the present disclosure should appreciate that the communication system 100 may include any desirable number of mobile devices 115(1-2). The mobile devices 115(1-2) and may form wireless communication links with the wireless network 105 over air interfaces 120(1-2). In various alternative embodiments, the air interfaces 120(1-2) may be established according to any desirable system including, but not limited to, the exemplary wireless communication systems discussed above.

In the illustrated embodiment, the wireless network 105 includes a mobile switching center (MSC) 123, which may be used to provide switching services to the wireless network 105. The wireless network 105 may be coupled to a packet data network 125 by a packet data switch node 130. The packet data network 125 may include an authentication, authorization, and accounting (AAA) module 135, a domain name server (DNS) 140, a soft switch 145, a messaging server 150, and a conference bridge 155. The packet data network 125 may also be communicatively coupled to a public Internet 160 via a firewall 165. Implementation and/or operation of the mobile switching center 123, the packet data network 125, the packet data switch node 130, the AAA module 135, the domain name server 140, the soft switch 145, the messaging server 150, the conference bridge 155, the public Internet 160, and the firewall 165 are known to persons of ordinary skill in the art and not material to the present invention. Thus, implementation and/or operation of these devices will not be discussed further herein.

The mobile devices 115(1-2) shown in FIG. 1 include graphical user interfaces 170(1-2). The graphical user interfaces 170(1-2) provide indications of one or more wireless communication links, such as a voice communication link, as will be discussed in detail below. However, persons of ordinary skill in the art should appreciate that the present invention is not limited to voice communications. In alternative embodiments, communication links for carrying other types of communication, such as instant messaging, text messaging, and the like may be used. The mobile devices 115 (1-2) may establish a wireless communication link in response to an indication provided using the graphical user interface 170(1-2) associated with the mobile device 115(1-2). In the illustrated embodiment, a point-to-talk server 175 may receive an indication of the wireless communication link from one of the mobile devices 115(1-2) and may form the wireless communication link in response to receiving the indication. For example, the mobile device 115(1) may form a wireless voice communication link with the mobile device 115(2) by pressing on an appropriate portion of a touch sensitive screen using a stylus. The indication may then be provided to the point-2-talk server 175, which may form the desired wireless communication link. However, persons of ordinary skill in the art having benefit of the present disclosure should appreciate that the present invention is not limited to wireless communication links between the mobile devices 115(1-2). In alternative embodiments, the mobile devices 115(1-2) may form wireless communication links with any desirable device.

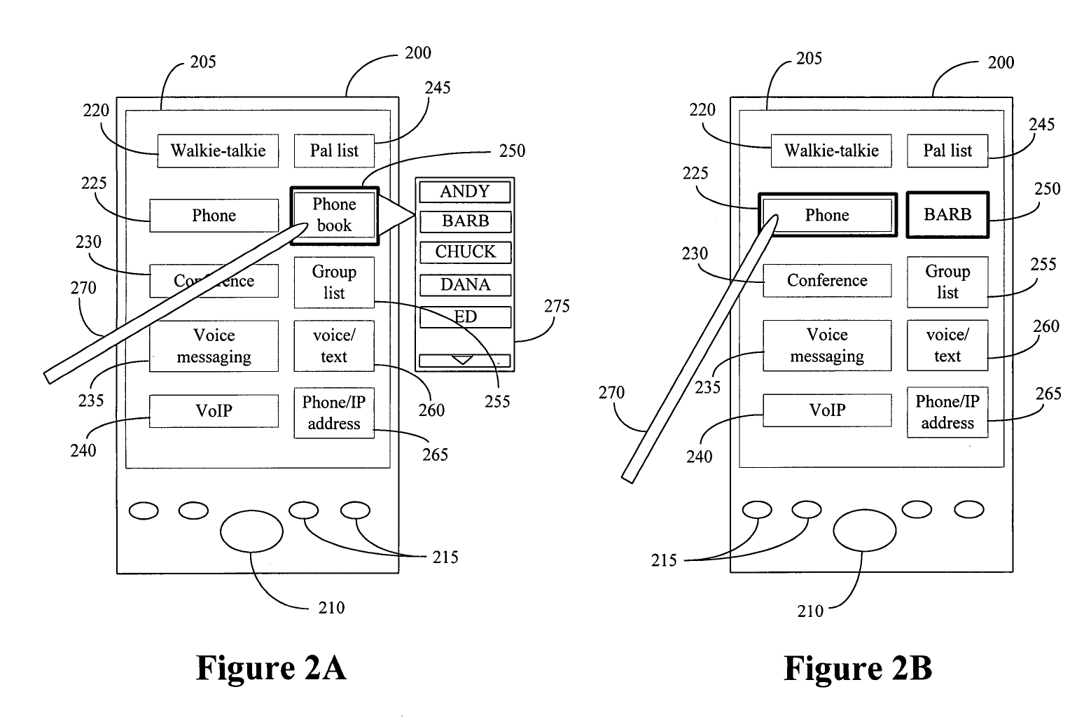

FIGS. 2A and 2B conceptually illustrate one exemplary embodiment of a mobile device 200. In the illustrated embodiment, the mobile device 200 includes a graphical user interface 205 and a plurality of buttons 210, 215. The buttons 210, 215 may perform more than one function, depending on the context, as will be discussed in detail below. The graphical user interface 205 displays information indicative of one or more functions that may be carried out by the mobile device 200. In the illustrated embodiment, portions of the graphical user interface 205 are associated with the various services and/or functions that may be performed by the mobile device 200.

The services that may be performed by the mobile device 200 may include, but are not limited to, a walkie-talkie dispatch service (indicated by the box 220 in the graphical user interface 205), a regular phone call (indicated by the box 225 in the graphical user interface 205), a conference call (indicated by the box 230), a voice messaging service (indicated by the box 235), and a Voice over Internet Protocol (VoIP) service (indicated by the box 240). The mobile device 200 may also provide additional functionality such as a pal list (indicated by the box 245) a phone book (indicated by the box 250), a group list (indicated by the box 255), a voice to text conversion program (indicated by the box 260), and a phone/IP address book (indicated by the box 265). Persons of ordinary skill in the art having benefit of the present disclosure should appreciate that this list of services and/or functions is intended to be exemplary and is not an exhaustive list of the possible services and/or functions that may be performed by the mobile device 200.

In operation, a user may select one or more functions using the graphical user interface 205. In the embodiment illustrated in FIG. 2A, a stylus 270 is used to select the phone book 250 by tapping on an appropriate touch-sensitive portion of the graphical user interface 205. The graphical user interface 205 may then display a drop-down menu 275 that includes indications of the names of people listed in the phone book 250. One or more of the people listed in the phone book 250 may then be selected by tapping on the appropriate portion of the drop-down menu 275 using the stylus 270. Other functions may be implemented in a similar manner. For example, tapping on the pal list 245 may result in a drop-down menu of pals being displayed, tapping on the group list 255 may result in a drop-down menu of groups being displayed, and tapping on the phone/IP address book 265 may result in a drop-down menu of address is being displayed. For another example, tapping on the voice-to-text button 260 may initiate a voice-to-text conversion.

The user may also initiate one or more wireless communication services using the graphical user interface 205. In the embodiment illustrated in FIG. 2B, tapping the phone box 225 with the stylus 270 initiates a wireless phone call to another user, e.g. the user BARB. Other wireless communication services may be initiated in a similar manner. For example, a walkie-talkie service may be initiated by tapping the walkie-talkie box 220, a conference call may be initiated by tapping the conference call box 230, a connection to a voice messaging service may be initiated by tapping the voice messaging box 235, and a VoIP connection may be initiated by tapping the VoIP box 240.

In one embodiment, the wireless communications services are provided in accordance with the selected functionality. For example, the wireless communication link may be formed using selected pals, numbers from a phone book, groups and the like. For another example, information provided over the wireless communication link may include text formed by the voice-to-text conversion function. The text may be used to leave a message in a voice messaging system or on a user's terminal device. Alternatively, a user may provide an indication of the desired wireless communication link. For example, the user may type in a phone number or an Internet address that may be used to establish the wireless communication link.

Although FIGS. 2A and 2B depict a stylus 270 that is used to tap touch sensitive portions of the graphical user interface 205, the present invention is not limited to this embodiment. In alternative embodiments, any desirable technique for providing the information indicative of the desired services and/or functionality via the graphical user interface 205 may be used. For example, the user may tap a touch sensitive portion of the graphical user interface 205 with a finger. For another example, a cursor and/or a mouse may be used to select one or more portions of the graphical user interface 205. For yet another example, the buttons 210, 215 may be associated with one or more portions of the graphical user interface 205 while the graphical user interface 205 is being displayed by the mobile device 200. The user may then press one or more of the buttons 210, 215 to provide the information indicative of the desired services and/or functionality.

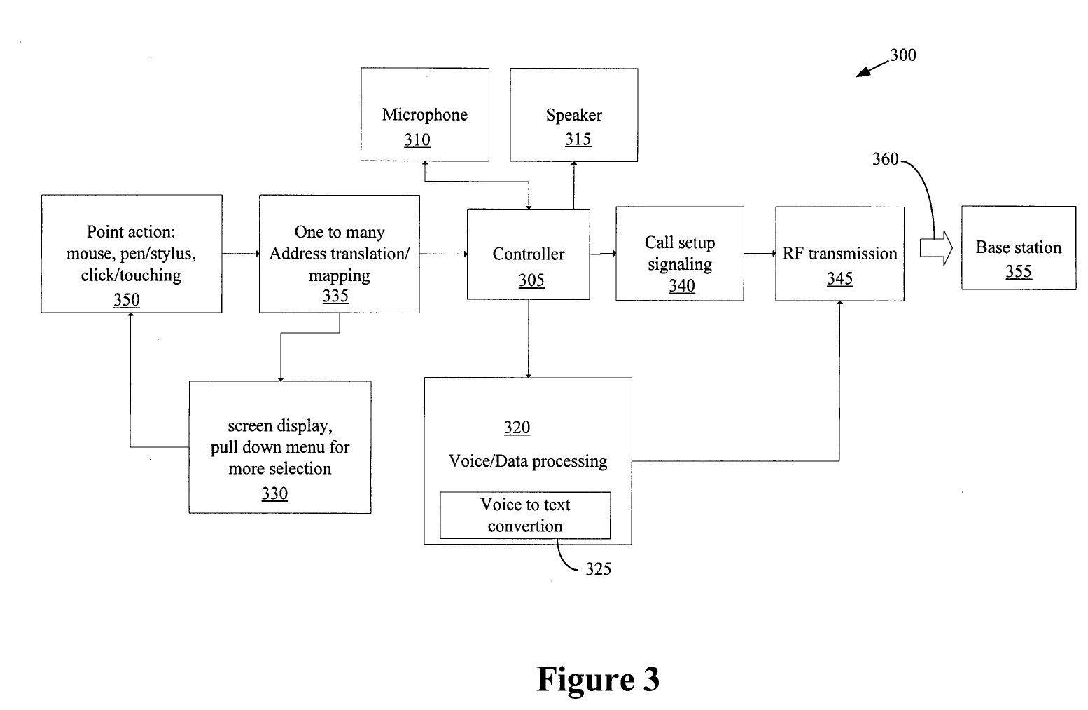

FIG. 3 conceptually illustrates operation of one exemplary embodiment of a mobile device 300, such as the mobile device 200 shown in FIGS. 2A and 2B, in accordance with the present invention. The boxes shown in FIG. 3 represent portions of the mobile device 300 and/or the operations that may be carried out by these portions. In the illustrated embodiment, the mobile device 300 includes a controller 305, a microphone 310, a speaker 315, and a voice/data processing module 320, which includes a voice-to-text conversion module 325. The illustrated mobile device 300 also includes a screen display 330, a mapping module 335, a signaling module 340, and a transmission module 345. However, persons of ordinary skill in the art should appreciate that the mobile device 300 may include additional modules that are capable of performing these or other functions. In various alternative embodiments, the modules may be implemented in software, hardware, or any combination thereof.

In operation, a graphical user interface is displayed on a screen of the mobile device 300, as indicated in box 330. The information displayed on the screen may include one or more pull-down menus to provide additional selections. A point action may be detected by the graphical user interface, as indicated in box 350. As discussed above, the point action may be performed using a mouse, a pen, a stylus, a finger, a clicking operation, a touching operation, and the like. The point action is used to initiate a wireless communication link and this may include performing address translation, address mapping, one-to-many address translation, and other operations, as indicated in box 335. When the user points to a link displayed by the graphical user interface and the point action has been detected by the graphical user interface, the mobile device 300 is in the off-hook state. When other people try to call the mobile device 300 while it is in the off-hook state, a busy signal will be sent over to the other party.

Information indicative of the pointing action, the address translation, and/or the address mapping may be provided to the controller 305, which may instruct the signal module 340 to set up the appropriate wireless communication link. The signal module 340 may then provide the appropriate signaling information to the transmission module 345 for transmission to a base station 355. In one embodiment, standard signaling protocols may be used to establish the point-to-talk wireless communication link. For example, either SIP (session initiated protocol) or MGCP (media gateway control protocol) can be used for setting up and/or tearing down a call.

The controller 305 may also receive voice information from the microphone 310 and provide audio information using the speaker 315. In one embodiment, the voice information provided by the microphone 310 may be provided to the voice/data processing module 320, which may provide information indicative of the voice information to the transmission module 345 for transmission over an air interface 360 to the base station 355. In some embodiments, the voice information may be converted to text information using the voice to text conversion module 325. The text information may then be provided to the transmission module 345 for transmission over the air interface 360 to the base station 355.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A method of wireless communication using a mobile unit, comprising:
establishing a wireless communication link in response to an indication provided using a graphical user interface associated with the mobile unit.

2. The method of claim 1, wherein establishing a wireless communication link comprises establishing a full-duplex wireless voice communication link.

3. The method of claim 1, comprising receiving the indication from the graphical user interface.

4. The method of claim 3, wherein receiving the indication from the graphical user interface comprises receiving an indication provided by at least one of a mouse, a stylus, a touch sensitive screen, and a button.

5. The method of claim 1, comprising providing the graphical user interface.

6. The method of claim 5, wherein providing the graphical user interface comprises providing at least one indication of at least one service option in at least one portion of the graphical user interface.

7. The method of claim 6, wherein providing at least one indication of at least one service option comprises providing at least one indication of at least one of a walkie-talkie dispatch service, a regular voice call service, a conference call, a group call, a Voice over Internet Protocol phone call, an instant messaging service, a text messaging service, and a voice messaging service.

8. The method of claim 5, wherein providing the graphical user interface comprises providing a list of users or groups of users.

9. The method of claim 5, wherein providing the graphical user interface comprises providing at least one pull-down window.

10. The method of claim 1, comprising receiving at least one voice signal.

11. The method of claim 10, comprising providing at least a portion of said at least one voice signal over the wireless communication link.

12. The method of claim 10, comprising converting at least a portion of said at least one voice signal to at least one text message.

13. The method of claim 12, comprising providing the at least one text message over the wireless communication link.

14. The method of claim 1, comprising receiving an indication of an incoming call.

15. The method of claim 14, comprising establishing the wireless communication link in response to receiving the indication of the incoming call.

16. The method of claim 14, comprising providing a busy signal in response to receiving the indication of the incoming call if the wireless communication link has been established.

17. A method of wireless communication with a mobile unit, comprising:
receiving an indication of a wireless communication link provided using a graphical user interface associated with the mobile unit; and
forming the wireless communication link in response to receiving the indication.

18. The method of claim 17, wherein forming the wireless communication link comprises forming a full-duplex wireless voice communication link.

19. The method of claim 17, wherein forming the wireless communication link comprises providing at least one of a walkie-talkie dispatch service, a regular voice call service, a conference call, a group call, a Voice over Internet Protocol phone call, an instant messaging service, a text messaging service, and a voice messaging service.

20. The method of claim 17, wherein forming the wireless communication link comprises forming the wireless communication link with at least one of a list of users and a group of users.

21. The method of claim 17, comprising receiving at least one voice signal over the wireless communication link and providing at least a portion of said at least one voice signal.

22. The method of claim 21, comprising converting at least a portion of said at least one voice signal to at least one text message.

23. The method of claim 22, comprising providing the at least one text message.

24. The method of claim 21, wherein providing at least a portion of said at least one voice signal comprises providing at least a portion of said at least one voice signal to at least one voice mailbox.
